(19) United States
(12) Patent Application Publication
(10) Pub. No.: US 2007/0013496 A1
(43) Pub. Date: Jan. 18, 2007

(54) Collision detection device for vehicle

(75) Inventor: Hisanori Miura, Gamagori-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/453,310

(22) Filed: Jun. 14, 2006

(30) Foreign Application Priority Data
Jun. 15, 2005 (JP) 2005-175192

(51) Int. Cl. B60Q 1/00

(52) U.S. Cl. 340/435

(57) ABSTRACT

A collision detection device for a vehicle has a control unit which determines a collision with the vehicle, a left main sensor arranged at the vehicle left portion, a right main sensor arranged at the vehicle right portion, a middle sub sensor arranged at the substantial middle portion of the vehicle, a left sub bus for connecting the middle sub sensor with the left main sensor, a left main bus for connecting the left main sensor with the control unit, a right sub bus for connecting the middle sub sensor with the right main sensor, and a right main bus for connecting the right main sensor with the control unit. Thus, the single middle sub sensor is provided for the collision detection of the vehicle right portion and that of the vehicle left portion, respectively with the right main sensor and the left main senor.

### CROSS REFERENCE TO RELATED APPLICATION

This application is based on a Japanese Patent Application No. 2005-175192 filed on Jun. 15, 2005, the disclosure of which is incorporated herein by reference.

### FIELD OF THE INVENTION

The present invention relates to a collision detection device, which detects a collision of a vehicle, for example.

### BACKGROUND OF THE INVENTION

Recently, vehicles having passenger protection devices increase. The passenger protection device (e.g., airbag apparatus) protects passengers in a collision of the vehicle. When the collision of the vehicle occurs, an airbag (airbag body) of the airbag apparatus is deployed to protect the upper portion of the passenger from colliding with an instrument panel of the vehicle or the like. The airbag apparatus is actuated by a collision detection device, which detects the collision of the vehicle.

The vehicle may have a facade collision which occurs at the front portion of the vehicle with an object (e.g., other vehicle), a flank collision which occurs at the flank portion (including right portion and left portion) of the vehicle, or the like. Therefore, collision detection sensors are respectively arranged at the vehicle right portion and the vehicle left portion and connected with an ECU through buses, considering the collision at the vehicle left portion and that at the vehicle right portion.

However, in the case where each of the vehicle right portion and the vehicle left portion is provided with the single collision detection sensor, it is possible for the airbag to be falsely deployed due to fault of the collision detection sensor and/or the bus (which connects collision detection sensor with ECU) notwithstanding no collision occurs at the vehicle right portion or the vehicle left portion.

According to the collision detection device with reference to JP-2004-256026A, collision detection units for the vehicle left portion and the vehicle right portion are provided with a redundancy design, to restrict the false deploy of the airbag. That is, a left collision detection main sensor having a relatively low sensitivity and a right collision detection sub sensor (safetying sensor) having a relatively high sensitivity are arranged at the vehicle left portion. A right collision detection main sensor having a relatively low sensitivity and a left collision detection sub sensor (safetying sensor) having a relatively high sensitivity are arranged at the vehicle right portion.

The right collision detection sub sensor is connected with the left collision detection main sensor through a sub bus, and the left collision detection main sensor is connected with the ECU through a main bus. The left collision detection sub sensor is connected with the right collision detection main sensor through a sub bus, and the right collision detection main sensor is connected with the ECU through a main bus.

In this case, the collision of the vehicle left portion is detected via the left collision detection main sensor arranged at the vehicle left portion, and the left collision detection sub sensor arranged at the vehicle right portion. The collision of the vehicle right portion is detected via the right collision detection main sensor arranged at the vehicle right portion, and the right collision detection sub sensor arranged at the vehicle left portion. Thus, even when the left collision detection main sensor falsely generates a detection signal due to the fault, the airbag will be restricted from being deployed if the left collision detection sub sensor does not generate the detection signal.

However, the collision detection device is provided with the two collision detection sub sensors (left collision detection sub sensor and right collision detection sub sensor), thus increasing the component number and the cost thereof. Moreover, for example, although the left collision detection main sensor at the vehicle left portion and the left collision detection sub sensor at the vehicle right portion are provided to detect the collision with the vehicle left portion, it is uncertainly for the impact due to the collision of the vehicle left portion to be substantially transmitted to the vehicle right portion considering the various vehicle sorts (e.g., minivan). As a result, notwithstanding the left collision detection main sensor generates the detection signal, the airbag may fail to deploy (that is, non-deploy) because the left collision detection sub sensor does not generate the detection signal.

### SUMMARY OF THE INVENTION

In view of the above-described disadvantages, it is an object of the present invention to provide a collision detection device for a vehicle, in which a malfunction and a non-function of a passenger protection device of the vehicle are restricted and a sub-sensor number is half-reduced.

According to an aspect of the present invention, a collision detection device for a vehicle has a control unit for determining a collision with the vehicle, a left collision detection main unit which is arranged at a left portion of the vehicle, a right collision detection main unit which is arranged at a right portion of the vehicle, a middle collision detection sub unit which is arranged at a substantial middle portion of the vehicle, a left connection sub unit which connects the middle collision detection sub unit with the left collision detection main unit, a left connection main unit for connecting the left collision detection main unit with the control unit, a right connection sub unit for connecting the middle collision detection sub unit with the right collision detection main unit, and a right connection main unit for connecting the right collision detection main unit with the control unit.

In this case, the single middle collision detection sub unit is connected with the left connection main unit through the left connection sub unit and connected with the right connection main unit through the right connection sub unit. That is, the collision detection device is provided with the single collision detection sub unit, so that the construction thereof is simplified and the cost thereof is reduced. Moreover, non-function and malfunction of the passenger protection device (e.g., false deploy and non-deploy of airbag unit) of the vehicle can be restricted.

According to another aspect of the present invention, a collision detection device for a vehicle has a control unit for determining a collision with the vehicle, a left collision detection main unit which is arranged at a left portion of the vehicle, a left connection main unit which connects the left collision detection main unit with the control unit, a right collision detection main unit which is arranged at a right portion of the vehicle, a right connection main unit which connects the right collision detection main unit with the control unit, a middle collision detection sub unit which is arranged at a substantial middle portion of the vehicle, and a middle connection sub unit which connects the middle collision detection sub unit with the control unit.

In this case, the single middle collision detection sub unit is connected with the control unit through the middle connection sub unit. That is, the collision detection device is provided with the single collision detection sub unit, so that the construction thereof is simplified and the cost thereof is reduced. Moreover, the non-function and malfunction of the passenger protection device can be restricted.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing a collision detection device for a vehicle according to a first embodiment of the present invention;

FIG. 2 is a schematic diagram showing a middle sub sensor according to the first embodiment;

FIG. 3 is a schematic diagram showing a first communication IC according to the first embodiment;

FIG. 4 is a schematic diagram showing a middle sub sensor according to a first modification of the first embodiment;

FIG. 5 is a schematic diagram showing a middle sub sensor according to a second modification of the first embodiment; and

FIG. 6 is a schematic diagram showing a collision detection device for a vehicle according to a second embodiment of the present invention.

### DETAILED DESCRIPTION OF THE EXAMPLE EMBODIMENTS

### First Embodiment

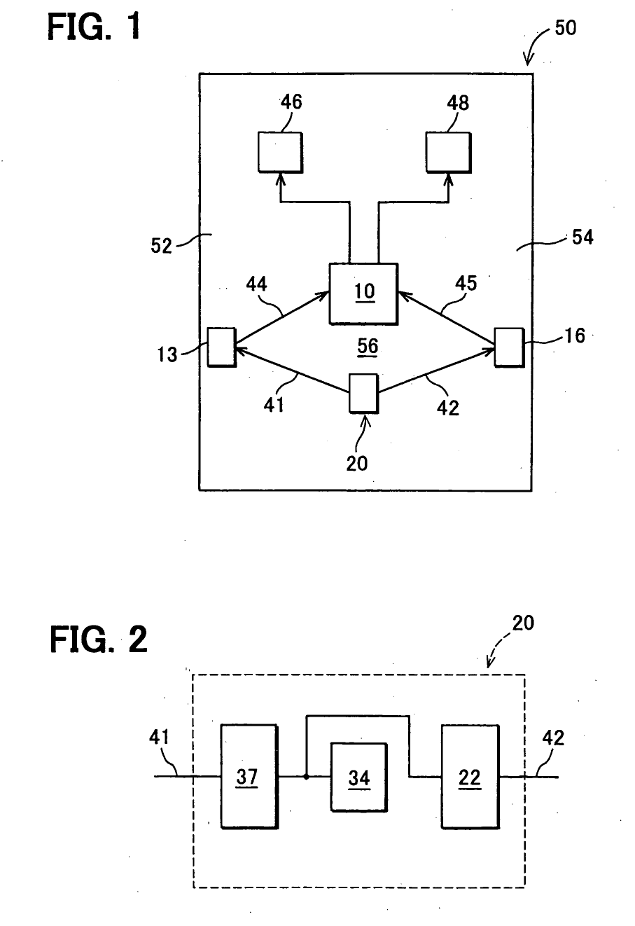

A collision detection device for a vehicle 50 according to a first embodiment of the present invention will be described with reference to FIGS. 1-5.

Referring to FIG. 1, the collision detection device has a control unit 10 (e.g., ECU), a left collision detection main unit 13 (e.g., left collision detection main sensor), a right collision detection main unit 16 (e.g., right collision detection main sensor), a left connection main unit 44 (e.g., left main bus), a right connection main unit 45 (e.g., right main bus), a middle collision detection sub unit 20 (e.g., middle collision detection sub sensor), a left connection sub unit 41 (e.g., left sub bus), a right connection sub unit 42 (e.g., right sub bus), a left passenger protection unit 46 (e.g., left airbag unit) and a right passenger protection unit 48 (e.g., right airbag unit).

The ECU 10 determines a collision with the vehicle 50 based on detection signals from the detection units, to actuate the left airbag unit 46 and the right airbag unit 48. The ECU 10 can perform the collision determination via a determination member thereof, for example.

The left collision detection main sensor 13 (left main sensor) is arranged at a left portion 52 of the vehicle 50, and connected with the ECU 10 via the left main bus 44. The right collision detection main sensor 16 (right main sensor) is arranged at a right portion 54 of the vehicle 50, and connected with the ECU 10 via the right main bus 45. Each of the left main sensor 13 and the right main sensor 16 can be constructed of a general-purpose sensor to have a receiving member, a sending member and an acceleration sensor member.

The middle collision detection sub sensor 20 (middle sub sensor) is arranged at a middle portion 56 of the vehicle 50. The middle portion 56 includes a substantial width-direction middle of the vehicle 50 and the vicinity of the middle. The vehicle width direction corresponds to the vehicle left-right direction.

As shown in FIG. 2, the middle sub sensor 20 includes an acceleration sensor member 34 (e.g., G sensor) for detecting an acceleration of the vehicle 50, a first communication member 22 (e.g., communication IC) for signal-swapping (signal-exchanging) between the right main sensor 16 and the ECU 10, and a second communication member 37 (e.g., communication IC) for signal-swapping between the left main sensor 13 and the ECU 10. That is, the middle sub sensor 20 has two communication systems.

The acceleration sensor member 34 is disposed to distinguish between the collision of the right portion 54 and the collision of the left portion 52. For example, the acceleration sensor member 34 generates positive signals in the case of the collision with the vehicle left portion 52, and generates the negative signal in the case of the collision with the vehicle right portion 54.

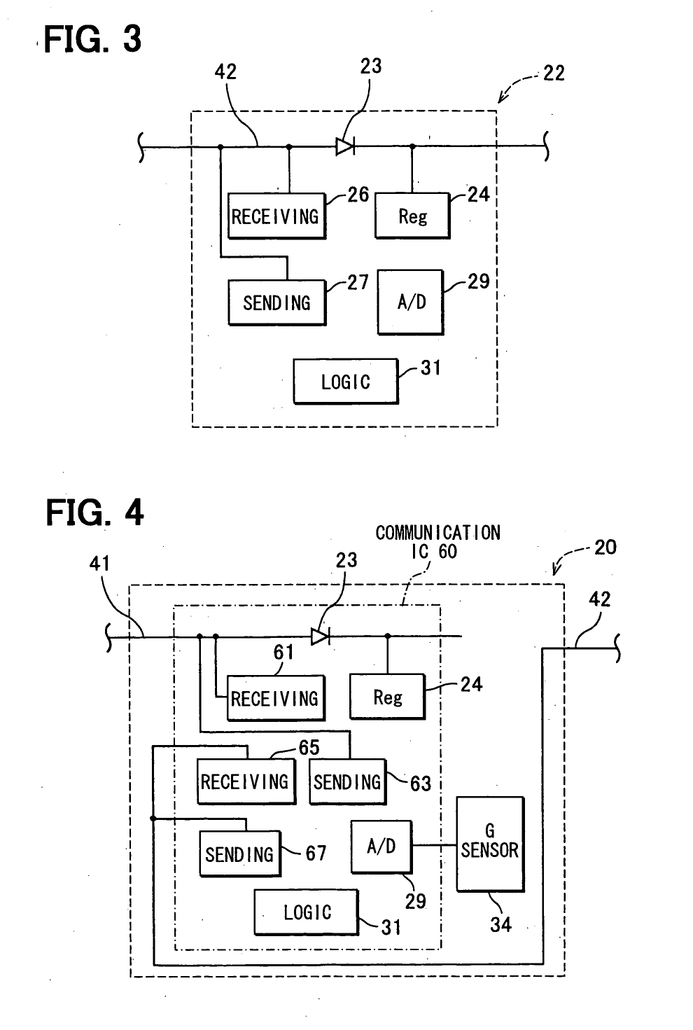

As shown in FIG. 3, the first communication IC 22 has a diode 23 which restricts current flow chiefly to one direction, a regulator 24 (e.g., 5v-regulator) functioning as a power member, a receiving member 26, a sending member 27, an A/D converter 29 and a logic member 31. The receiving member 26 receives signals such as address signals from the ECU 10 via the right sub bus 42 and the right main bus 45. The sending member 27 sends signals such as detection signals to the ECU 10 via the right sub bus 42 and the right main bus 45.

The A/D converter 29 converts analog signals of the acceleration sensor member 34 into digital signals. The logic member 31 controls the operation of the whole of the first communication IC 22. Specifically, the logic member 31 processes a command form the ECU 10 and performs the A/D conversion according to the command, to suitably send the signals.

The second communication IC 37, has a same construction with the first communication IC 22 as shown in FIG. 3, to swap (exchange) the signals between the ECU 10 and the left main sensor 13 through the left sub bus 41 and the left main bus 44.

Next, the function of the collision detection device according to the first embodiment will be described. Referring to FIG. 1, if an object such as other vehicle collides with the left portion 52 of the own vehicle 50, the acceleration sensor member of the left main sensor 13 detects the collision between the vehicle 50 and the object. The detection signal of the left main sensor 13 is sent to the ECU 10 through the left main bus 44. Moreover, the collision of the left portion 52 is detected by the acceleration sensor member 34 of the middle sub sensor 20, so that the middle sub sensor 20 outputs the positive signal.

The detection signal of the middle sub sensor 20 is sent to the ECU 10 form the receiving member 26 of the first communication IC 22 through the right sub bus 42, the right main sensor 16 and the right main bus 45. The detection signals from the left main sensor 13 and the middle sub sensor 20 are compared with, for example, a threshold value of the collision determination member by the ECU 10. In the case where it is determined that the possibility of the collision is high, the ECU 10 sends an actuation signal to the left airbag unit 46 to actuate the left airbag unit 46.

In the case where the object collides with the right portion 54 of the vehicle 50, the collision is detected by the right main sensor 16 and the middle sub sensor 20 (which generates negative signal in this case). The detection signal of the right main sensor 16 is sent to the ECU 10 through the right main bus 45. In this case, the detection signal of the middle sub sensor 20 is sent from the second communication IC 37 to the ECU 10 through the left sub bus 41 and the left main bus 44. Similarly, the detection signals from the right main sensor 16 and the middle sub sensor 20 are compared with, for example, a threshold value of the collision determination member by the ECU 10. In the case where it is determined that the possibility of the collision is high, the ECU 10 sends an actuation signal to the right airbag unit 48 to actuate the right airbag unit 48.

According to the first embodiment, the false deploy (malfunction) of the left airbag unit 46 and the right airbag unit 48 can be restricted. For example, the collision with the left portion 52 is detected via the left main sensor 13 mounted at the left portion 52 and the middle sub sensor 20 mounted at the middle portion 56. Thus, even when the signal is inputted into the ECU 10 through the left main bus 44 due to electrical noise or the like (in left main sensor 13 and/or left main bus 44) notwithstanding no collision with the left portion 52 occurs, the signal due to electrical noise will not enter the ECU 10 through the right sub bus 42 and the right main bus 45 because the different communication systems are used. Moreover, in this case, the middle sub sensor 20 will not generate the detection signal, so that the ECU 10 is not provided with the detection signal via the right sub bus 42 and the right main bus 45. Therefore, the ECU 10 will not send the actuation signal to the left airbag unit 46. That is, the left airbag unit 46 will not be deployed.

Moreover, according to the first embodiment, the non-deploy (non-function) of the left airbag unit 46 and the right airbag unit 48 can be restricted. For example, because the impact on the vehicle 50 due to the collision with the left portion 52 is readily transmitted to the middle portion 56, the impact can be substantially detected by the middle sub sensor 20 arranged at the middle portion 56. Therefore, even when the detection signal fails to be transmitted to the ECU 10 from the left main sensor 13 and the left main bus 44 when the collision occurs (for example, due to fault of left main sensor 13 and/or left main bus 44), the detection signal of the middle sub sensor 20 can be sent to the ECU 10 through the right sub bus 42 and the right main bus 45 so that the left airbag unit 46 is actuated.

Furthermore, the middle sub sensor 20 is shared as a safetying senor for detecting the collision of the left portion 52, and that for detecting the collision of the right portion 54. Therefore, according to this embodiment, the sub-sensor number of the collision detection device is half-reduced, as compared with a conventional collision detection device where two sub sensors are used. Thus, the cost can be reduced.

Next, a first modification of the first embodiment will be described. As shown in FIG. 4, the middle sub sensor 20 positioned at the middle portion 56 can be also provided with a single communication member 60 (e.g., communication IC).

In this case, in addition to the A/D converter 29, the logic member 31, the regulator 24, the diode 23, the communication IC 60 has a first receiving member 61 and a first sending member 63 which are provided for the sake of signal-swapping with the ECU 10 through the left sub bus 41 and the left main bus 44, and a second receiving member 65 and a second sending member 67 which are provided for the sake of signal-swapping with the ECU 10 through the right sub bus 42 and the right main bus 45. The middle sub sensor 20 receives the command signal from the ECU 10 through the left sub bus 41 and the left main bus 44, or through the right sub bus 42 and the right main bus 45.

According to the first modification, the middle sub sensor 20 has the single communication IC 60, so that the single diode 23, the single regulator 24, the single A/D converter 29 and the single logic member 31 are provided. Therefore, the dimension and the cost of the collision detection device can be further reduced.

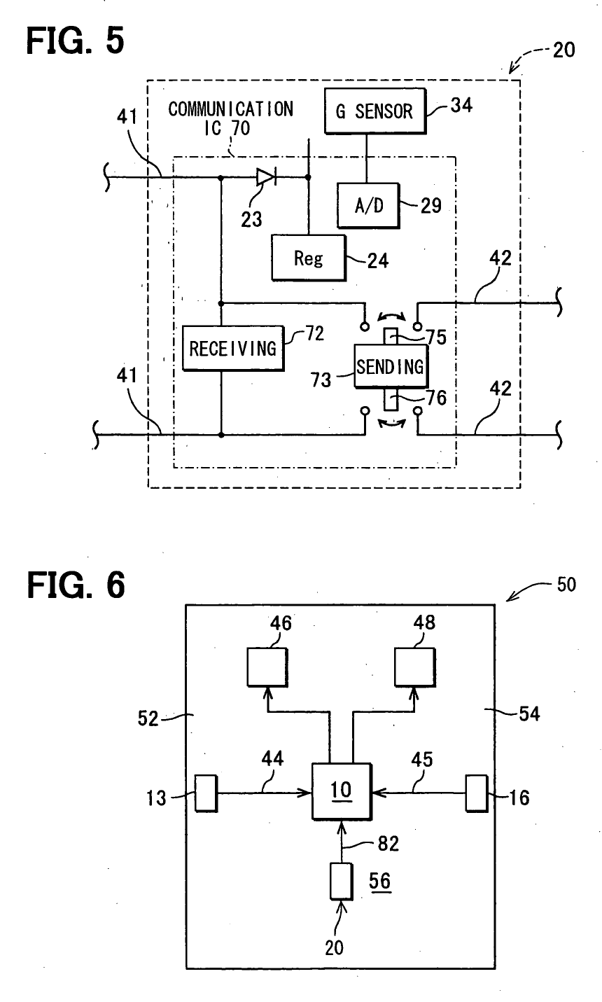

Next, a second modification of the first embodiment will be described. As shown in FIG. 5, the middle sub sensor 20 can be also provided with a single communication member 70 (e.g., communication IC), which has a single receiving member 72 and a single sending member 73. The communication IC 70 is further provided with switches 75 and 76, through which signal-swapping with the ECU 10 is switched to be performed via the left sub bus 41 or via the right sub bus 42.

In this case, the middle sub sensor 20 receives the command from the ECU 10 through the right sub bus 42 and the right main bus 45, so that the switches 75 and 76 are simultaneously switched at a short cycle responding to the command. Thus, at the instant when there is the detection signal from the acceleration sensor member 34, the detection signal is sent to the ECU 10 via the right sub bus 42 and the right main bus 45. At other instant, the sending to the ECU 10 is performed via the left sub bus 41 and the left main bus 44. That is, the middle sub sensor 20 is provided with a timeshared control by the ECU 10.

According to the second modification of the first embodiment, the single communication IC 70 having the single receiving member 72 and the single sending member 73 is provided, so that the communication IC 70 and the middle sub sensor 20 can be small-sized.

According to the first embodiment (including first modification and second modification thereof), the single left main sensor 13 (left collision detection main sensor) is arranged at the vehicle left portion 52. The single right main sensor 16 (right collision detection main sensor) is arranged at the vehicle right portion 54. The single middle sub sensor 20 (middle collision detection sub sensor) is arranged at the vehicle middle portion 56. In this case, the middle portion 56 is the wide range including the substantial middle of the vehicle 50 and the vicinity thereof.

Each of the left main sensor 13 and the right main sensor 16 can be constructed of the general-purpose sensor (having acceleration sensor, receiving member and sending member). The left main sensor 13 and the right main sensor 16 are connected with the ECU 10 respectively through the left main bus 44 and the right main bus 45. The middle sub sensor 20 is connected with the left main sensor 13 through the left sub bus 41, and connected with the right main sensor 16 through the right sub bus 42.

Recently, a vehicle communication network has been developed. Various vehicle-mounted apparatuses are connected with each other via the communication network including buses and connectors for the sake of signal-exchanging.

According to the first embodiment, the middle sub sensor 20 has the acceleration sensor member 34, and the two communication members 22 and 37. The acceleration sensor member 34 generates the positive signal in the case of the collision with the vehicle left portion 52, and generates the negative signal in the case of the collision with the vehicle right portion 54. The communication member 22, 37 is constructed of the communication IC or the like, which is provided with the single receiving member 26 and the single sending member 37. The communication IC 22 and 37 are respectively connected with the left sub bus 41 and the right sub bus 42.

Alternatively, according to the first modification of the first embodiment, the middle sub sensor 20 is provided with the acceleration sensor 34, and the single communication member 60 (constructed of communication IC or the like) which has the two receiving members 61, 65 and the two sending members 63, 67. The receiving member 61 and the sending member 63 are connected with the left sub bus 41. The receiving member 65 and the sending member 67 are connected with the right sub bus 42.

More alternatively, according to the second modification of the first embodiment, the middle sub sensor 20 is provided with the acceleration sensor 34, and the single communication member 70. The communication member 70 (constructed of communication IC or the like) has the single sending member 73, the single receiving member 72, and the switches 75 and 76. In this case, the ECU 10 provides the timeshared control for the sending of the sending member 73.

According to the first embodiment (including first modification and second modification thereof), the collision with the vehicle left portion 52 is detected via the left main sensor 13 and the middle sub sensor 20. In this case, the detection signal of the left main sensor 13 is sent to the ECU 10 through the left main bus 44. The detection signal of the middle sub sensor 20 is sent to the ECU 10 through the right sub bus 42 and the right main bus 45. The collision determination member of the ECU 10 determines the collision with the vehicle left portion 52 based on the detection signals from the left main sensor 13 and the middle sub sensor 20.

On the other hand, the collision with the vehicle right portion 54 is detected by the right main sensor 16 and the middle sub sensor 20. In this case, the detection signal of the right main sensor 16 is sent to the ECU 10 through the right main bus 45. The detection signal of the middle sub sensor 20 is sent to the ECU 10 through the left sub bus 41 and the left main bus 44. Thus, the collision determination member of the ECU determines the collision with the vehicle right portion 54 based on the detection signals of the right main sensor 16 and the middle sub sensor 20.

Thus, the collision determination for the vehicle left portion 52 and the vehicle right portion 54 are provided with the redundancy, so that the malfunction of the whole of the collision detection device due to the fault of part of the sensors and the buses can be restricted.

In the case where the collision detection main sensor 13, 16 does not generate the detection signal, it is considered that the fault of the collision detection main sensor 13, 16 or the like may occur, in addition to that no collision occurs. Therefore, in this case, the detection signal of the middle sub sensor 20 is also used for the collision determination at OR condition with respect to the signal of the collision detection main sensor 13, 16, to restrict the non-deploy of the airbag unit 46, 48.

On the other hand, in the case where the signal is generated in the collision detection main sensor 13, 16, it is considered that the electrical noise may occur, in addition to that the collision occurs. Therefore, in this case, the detection signal of the middle sub sensor 20 is also used for the collision determination at AND condition with respect to the signal of the collision detection main sensor 13, 16, to restrict the false deploy of the airbag unit 46, 48.

The sensitivity of the collision detection sub sensor 20 can be set higher than those of the collision detection main sensors 13 and 16. The passenger protection device of the vehicle 50 can include the airbag units 46, 48, seatbelt pre-tensioner units or the like.

### Second Embodiment

A second embodiment of the present invention will be described with reference to FIG. 6. In this case, the middle collision detection sub sensor 20 (middle sub sensor) is constructed of a general-purpose sensor (similarly to left main sensor 13 and right main sensor 16), to have an acceleration sensor member, a receiving member and a sending member. The receiving member and the sending member are connected with the ECU 10 via a single middle sub bus 82.

The middle sub sensor 20 is arranged at the middle portion 56 of the vehicle 50. The acceleration sensor member of the middle sub sensor 20 outputs the positive signal from the sending member thereof in the case of the collision at the vehicle left portion 52, and outputs the negative signal from the sending member thereof in the case of the collision at the vehicle right portion 54.

The signals from the middle sub sensor 20 are transmitted to the ECU 10 through the middle sub bus 82. In this case, the collision of the vehicle left portion 52 is detected via the detection signal of the left main sensor 13 and the positive signal of the middle sub sensor 20. The collision of the vehicle right portion 54 is detected via the detection signal of the right main sensor 16 and the negative signal of the middle sub sensor 20.

According to the second embodiment, the single left main sensor 13, the single right main sensor 16, and the middle sub sensor 20 are respectively arranged at the vehicle left portion 52, the vehicle right portion 54 and the vehicle middle portion 56. The left main sensor 13 and the right main sensor 16 are connected with the ECU 10, respectively through the left main bus 44 and the right main bus 45. The middle sub sensor 20 is connected with the ECU 10 through the middle sub bus 82.

Therefore, for example, when the electrical noise enters the left main sensor 13 and/or the left main bus 44 to input the signal to the ECU 10 notwithstanding no collision with the vehicle left portion 52 occurs, electrical noise signal will not be sent from the middle sub sensor 20 to the ECU 10 through the middle sub bus 82. Thus, the ECU 10 will not send the actuation signal to the left airbag unit 46. Therefore, the false deploy of the left airbag unit 46, 48 can be restricted.

Moreover, for example, in the case where there occurs the collision with the left portion 52 and the detection signal fails to be transmitted to the ECU 10 due to the failure of the left main sensor 13 and/or the left main bus 44, the middle sub sensor 20 (capable of detecting impact on middle portion 56 due to collision) can send the detection signal to the ECU 10 via the middle sub bus 82. Thus, the left airbag unit 46 can be actuated by the actuation signal from the ECU 10. Therefore, the non-deploy of the left airbag unit 46, 48 can be restricted.

According to this embodiment, the middle sub sensor 20 is connected with the ECU 10 through the single middle sub bus 82. The middle-sub sensor 20 has the acceleration sensor and the single communication member, which can be constructed of the communication IC having the single receiving member and the single sending member. The receiving member and the sending member are connected with the middle sub bus 82. In this case, the cost of the collision detection device can be further reduced because the single collision detection sub sensor 20 and the single sub bus 82 are provided.

In the second embodiment, the collision with the vehicle left portion 52 is detected via the left main sensor 13 and the middle sub sensor 20. The detection signal of the left main sensor 13 is sent to the ECU 10 through the left main bus 44, and the detection signal of the middle sub sensor 20 is sent to the ECU 10 through the middle sub bus 82. The collision determination member of the ECU 10 determines the collision with the vehicle left portion 52 based on the detection signals of the left main sensor 13 and the middle sub sensor 20.

On the other hand, the collision with the vehicle right portion 54 is detected via the right main sensor 16 and the middle sub sensor 20. The detection signal of the right main sensor 16 is sent to the ECU 10 through the right main bus 45, and the detection signal of the middle sub sensor 20 is sent to the ECU 10 through the middle sub bus 82. The collision determination member of the ECU 10 determines the collision with the vehicle right portion 54 based on the detection signals of the right main sensor 16 and the middle sub sensor 20.

In the case where the collision detection main sensor 13, 16 (which are respectively arranged at vehicle left portion 52 and vehicle right portion 54) does not generate the detection signal, it is considered that the fault of the collision detection main sensor 13, 16 or the like may occur, in addition to that no collision occurs. Therefore, in this case, the detection signal of the middle sub sensor 20 is also used for the collision determination at OR condition with respect to the signal of the collision detection main sensor 13, 16, to restrict the non-deploy of the airbag unit 46, 48.

On the other hand, in the case where the signal is generated in the collision detection main sensor 13, 16, it is considered that the electrical noise may occur, in addition to that the collision occurs. Therefore, in this case, the detection signal of the middle sub sensor 20 is also used for the collision determination at AND condition with respect to the signal of the collision detection main sensor 13, 16, to restrict the false deploy of the airbag unit 46, 48.

In the second embodiment, what has not been described about the collision detection device is the same with the first embodiment.

What is claimed is:

1. A collision detection device for a vehicle, comprising:
a control unit for determining a collision with the vehicle;
a left collision detection main unit which is arranged at a left portion of the vehicle;
a right collision detection main unit which is arranged at a right portion of the vehicle;
a middle collision detection sub unit which is arranged at a substantial middle portion of the vehicle;
a left connection sub unit which connects the middle collision detection sub unit with the left collision detection main unit;
a left connection main unit for connecting the left collision detection main unit with the control unit;
a right connection sub unit for connecting the middle collision detection sub unit with the right collision detection main unit; and
a right connection main unit for connecting the right collision detection main unit with the control unit.

2. The collision detection device according to claim 1, wherein:
the control unit is an ECU, which has a collision determination member for determining the collision with the vehicle;
the left collision detection main unit, the right collision detection main unit and the middle collision detection sub unit are respectively a left collision detection main sensor, a right collision detection main sensor and a middle collision detection sub sensor; and
the left connection main unit, the left connection sub unit, the right connection main unit and the right connection sub unit are respectively a left main bus, a left sub bus, a right main bus and a right sub bus.

3. The collision detection device according to claim 2, wherein:
the collision determination member of the ECU determines the collision with the left portion of the vehicle, based on signals which are detected by the left collision detection main sensor and sent to the ECU through the left main bus and signals which are detected by the middle collision detection sub sensor and sent to the ECU through the right sub bus and the right main bus; and
the collision determination member of the ECU determines the collision with the right portion of the vehicle, based on signals which are detected by the right collision detection main sensor and sent to the ECU through the right main bus and signals which are detected by the middle collision detection sub sensor and sent to the ECU through the left sub bus and the left main bus.

4. The collision detection device according to claim 3, wherein:
the middle collision detection sub sensor has an acceleration sensor member, a first communication member which is connected with the right sub bus, and a second communication member which is connected with the left sub bus; and
each of the first communication member and the second communication member has a receiving member and a sending member.

5. The collision detection device according to claim 3, wherein
the middle collision detection sub sensor has an acceleration sensor member, and a communication member which is connected with the right sub bus and the left sub bus.

6. The collision detection device according to claim 4, wherein
the acceleration sensor member of the middle collision detection sub sensor is disposed to distinguish between the collision with the right portion of the vehicle and the collision with the left portion of the vehicle.

7. The collision detection device according to claim 5, wherein
the acceleration sensor member of the middle collision detection sub sensor is disposed to distinguish between the collision with the right portion of the vehicle and the collision with the left portion of the vehicle.

8. A collision detection device for a vehicle, comprising:
a control unit for determining a collision with the vehicle;
a left collision detection main unit which is arranged at a left portion of the vehicle;
a left connection main unit which connects the left collision detection main unit with the control unit;
a right collision detection main unit which is arranged at a right portion of the vehicle;
a right connection main unit which connects the right collision detection main unit with the control unit;
a middle collision detection sub unit which is arranged at a substantial middle portion of the vehicle; and
a middle connection sub unit which connects the middle collision detection sub unit with the control unit.

9. The collision detection device according to claim 8, wherein:
the control unit is an ECU, which has a collision determination member for determining the collision with the vehicle;
the left collision detection main unit, the right collision detection main unit and the middle collision detection sub unit are respectively a left collision detection main sensor, a right collision detection main sensor and a middle collision detection sub sensor; and
the left connection main unit, the right connection main unit and the middle connection sub unit are respectively a left main bus, a right main bus and a middle sub bus.

10. The collision detection device according to claim 9, wherein:
the collision determination member of the ECU determines the collision with the left portion of the vehicle, based on signals which are detected by the left collision detection main sensor and sent to the ECU through the left main bus and signals which are detected by the middle collision detection sub sensor and sent to the ECU through the middle sub bus; and
the collision determination member of the ECU determines the collision with the right portion of the vehicle, based on signals which are detected by the right collision detection main sensor and sent to the ECU through the right main bus and signals which are detected by the middle collision detection sub sensor and sent to the ECU through the middle sub bus.

11. The collision detection device according to claim 10, wherein
the middle collision detection sub sensor has an acceleration sensor member, which is disposed to distinguish between the collision with the right portion of the vehicle and the collision with the left portion of the vehicle.

12. The collision detection device according to claim 5, wherein
the communication member has a first receiving member and a first sending member for signal-swapping with the ECU through the left sub bus and the left main bus, and a second receiving member and a second sending member for signal-swapping with the ECU through the right sub bus and the right main bus.
